(19) United States
(12) Patent Application Publication
(10) Pub. No.: US 2003/0087774 A1
(43) Pub. Date: May 8, 2003

(54) Fragrance compositions for the CO2 washing process

(76) Inventors: Leslie C. Smith, Princeton, NJ (US); Keith McDermott, Bound Brook, NJ (US); Steffen Sonnenberg, Holzminden (DE); Jijie Judy Zhuang, Raritan, NJ (US); Anja Finke, Holzminden (DE)

Correspondence Address: BAYER CORPORATION, PATENT DEPARTMENT, 100 BAYER ROAD, PITTSBURGH, PA, 15205, US

(21) Appl. No.: 09/915,716

(22) Filed: Jul. 26, 2001

(51) Int. Cl. C11D 1/00; C11D 3/50

(52) U.S. Cl. 510/101; 510/267

(57) ABSTRACT

A process for cleaning soiled garments and fabric materials using a liquid or supercritical CO₂ system, whereby a fragrance system having at least 75% of the ingredients having a relative fabric affinity value (y) of at least 4 or having at least 60% of the ingredients having a relative fabric affinity value (y) of at least 6 is added to the CO₂ is disclosed. The fragrance system, once it is applied on the garment and/or fabric material, is substantive and gives a long lasting odor.

### FIELD OF THE INVENTION

The present invention relates to a process for cleaning soiled garments and fabric materials using a liquid or supercritical CO₂ system, whereby a fragrance system contains 75% of fragrance ingredients having a relative substantivity value (y) of at least 4. The fragrance ingredients, once they are applied from the washing process, will result in the garment and/or fabric material having a substantive odor.

### BACKGROUND OF THE INVENTION

Today, dry cleaning systems typically use chlorinated hydrocarbons as a solvent. The use of chlorinated hydrocarbons can result in environmental, health, and cost problems.

Generally, garments, which are cleaned by dry cleaning systems, are at best, without any odor. More often than not, such “clean” garments will have a “chemical” or foul smell.

The use of liquid carbon dioxide avoids many of the environmental, health and cost problems associated with the more common solvents, and is more effective in cleaning than traditional dry cleaning methods.

Townsend, et al. (U.S. Pat. No. 5,784,905) discloses a liquid carbon dioxide dry cleaning system having a pressurized vessel into which garments are loaded into for cleaning. A conductive perforated cleaning drum is also disposed within the vessel. Liquid carbon dioxide is pumped into the pressurizable vessel from a pressurized storage tank. The vessel also contains an agitating means for agitating the garments during cleaning. To improve the fabric aesthetics, an antistatic agent is added to the dry cleaning fluid to dissipate the static charge generated by the friction. An odorizing agent or deodorizing agent is added to the cleaning solution to improve the “olfactory” output of the cleaning process, or “an improved liquid carbon dioxide dry cleaning fluid”.

However, fragrances that are normally suitable for traditional washing machines using water and detergent do not provide enough substantivity in this system. Substantivity is defined as the deposition of fragrance ingredients on the dry fabric, which results in a long lasting odor. In order to enhance the substantivity of fragrance ingredients on the fabric, a tailor-made fragrance composition is required.

Bacon, et al. (U.S. Pat. No. 5,500,138) describes fragrance compositions for the traditional fabric washing process using water, detergent and/or fabric softeners. In this patent, molecular descriptors such as ClogP and boiling point are used to identify enduring fragrance chemicals with increased substantivity on fabric. Utilizing ClogP and boiling point descriptors to build an understanding of fragrance chemical deposition on fabric during the CO₂ washing process leads to an incomplete picture.

The present invention uses advanced molecular modeling techniques to select fragrance ingredients to not only improve the odor of the liquid carbon dioxide but also to increase the deposition of fragrance ingredients, producing a substantive odor on the garment itself. Furthermore, the present invention also contemplates supercritical CO₂ as a solvent. Finally, the present invention contemplates not only dry-cleaning systems, but also any wash systems using CO₂ as a solvent.

### SUMMARY OF THE INVENTION

The present invention relates to a process for cleaning soiled garments or fabric materials comprising the steps of:

A) Placing said soiled garments or fabric materials into a sealable and pressurizable device;

B) Introducing into the device a cleaning agent comprising CO₂, which comprises a fragrance system;

C) Contacting said soiled garments or fabric materials with said cleaning fluid to remove undesired stains or soils and to deposit a substantive long-lasting fragrance on said garment or fabric materials.

### BRIEF DESCRIPTION OF THE DRAWINGS

FIG. 1 shows the correlation between boiling point and % left on the fabric from this CO₂ matrix.

FIG. 2 shows there is no correlation between logP (the octanol/water partition) and % left on the fabric.

FIG. 3 shows the correlation between −log (vapor pressure) and % left on the fabric.

### DETAILED DESCRIPTION OF THE INVENTION

The present invention relates to a wash or dry cleaning system for cleaning garments and/or fabrics, in which a fragrance system is added into a cleaning agent.

The cleaning agent is either liquid or supercritical carbon dioxide.

The critical temperature of carbon dioxide is 31° C. and the dense (or compressed) gas phase above the critical temperature and near (or above) the critical pressure is often referred to as “supercritical” carbon dioxide.

The CO₂ cleaning process also contains a fragrance system. Some non-limiting examples of how the fragrance system can be incorporated into the cleaning system: pre-blending the fragrance system to the liquid or super critical CO₂ before or during the washing process. These can include solid forms such as but not limited to tablets, sheets, powders and gels or liquid forms such as solutions or the pure fragrance.

The fragrance system of the present invention contains fragrance ingredients and mixtures thereof. Such fragrance ingredients according to the present invention can be found, for example, in S. Arctander, Perfume and Flavor Materials, Vols. 1 and 11, Monclair, N. N., 1969, Selbstverlag or K. Bauer, D. Garbe and H. Surburg, Common Fragrances and Flavor Materials, 3^{rd} Ed., Wiley-VCH, Weinheim 1997.

The following are examples of fragrance ingredients:

extracts from natural raw materials such as essential oils, concretes, absolutes, resins, resinoids, balsams, tinctures such as for example ambergris tincture; amyris oil; angelica seed oil; angelica root oil; aniseed oil; valerian oil; basil oil; tree moss absolute; bay oil; armoise oil; benzoe resinoid; bergamot oil; beeswax absolute; birch tar oil; bitter almond oil; savory oil; buchu leaf oil; cabreuva oil; cade oil; calamus oil; camphor oil; cananga oil; cardamom oil; cascarilla oil; cassia oil; cassie absolute; castoreum absolute; cedar leaf oil; cedar wood oil; cistus oil; citronella oil; lemon oil; copaiba balsam; copaiba balsam oil; coriander oil; costus root oil; cumin oil; cypress oil; davana oil; dill weed oil; dill seed oil; eau de brouts absolute; oakmoss absolute; elemi oil; estragon oil; eucalyptus citriodora oil; eucalyptus oil (cineole type); fennel oil; fir needle oil; galbanum oil; galbanum resin; geranium oil; grapefruit oil; guaiacwood oil; gurjun balsam; gurjun balsam oil; helichrysum absolute; helichrysum oil; ginger oil; iris root absolute; iris root oil; jasmine absolute; calamus oil; blue camomile oil; Roman camomile oil; carrot seed oil; cascarilla oil; pine needle oil; spearmint oil; caraway oil; labdanum oil; labdanum absolute; labdanum resin; lavandin absolute; lavandin oil; lavender absolute; lavender oil; lemon-grass oil; lovage oil; lime oil distilled; lime oil expressed; linaloe oil; Litsea cubeba oil; laurel leaf oil; mace oil; marjoram oil; mandarin oil; massoi (bark) oil; mimosa absolute; ambrette seed oil; musk tincture; clary sage oil; nutmeg oil; myrrh absolute; myrrh oil; myrtle oil; clove leaf oil; clove bud oil; neroli oil; olibanum absolute; olibanum oil; opopanax oil; orange flower absolute; orange oil; origanum oil; palmarosa oil; patchouli oil; perilla oil; Peru balsam oil; parsley leaf oil; parsley seed oil; petitgrain oil; peppermint oil; pepper oil; pimento oil; pine oil; pennyroyal oil; rose absolute; rosewood oil; rose oil; rosemary oil; Dalmatian sage oil; Spanish sage oil; sandalwood oil; celery seed oil: spike-lavender oil; star anise oil; storax oil; tagetes oil; fir needle oil; tea tree oil; turpentine oil; thyme oil; Tolu balsam; tonka bean absolute; tuberose absolute; vanilla extract; violet leaf absolute; verbena oil; vetiver oil; juniperberry oil; wine lees oil; wormwood oil; wintergreen oil; ylang-ylang oil; hyssop oil; civet absolute; cinnamon leaf oil; cinnamon bark oil; and fractions thereof or ingredients isolated therefrom;

individual fragrances from the group comprising hydrocarbons, such as for example 3-carene; α-pinene; β-pinene; α-terpinene; γ-terpinene; p-cymene; bisabolene; camphene; caryophyllene; cedrene; farnesene; limonene; longifolene; myrcene; ocimene; valencene; (E,Z)-1,3,5-undecatriene; styrene; diphenylmethane;

aliphatic alcohols, such as for example hexanol; octanol; 3-octanol; 2,6-dimethylheptanol; 2-methyl-2-heptanol, 2-methyl-2-octanol; (E)-2-hexenol; (E)- and (Z)-3-hexenol; 1-octen-3-ol; a mixture of 3,4,5,6,6-pentamethyl-3/4-hepten-2-ol and 3,5,6,6-tetramethyl-4-methyleneheptan-2-ol; (E,Z)-2,6-nonadienol; 3,7-dimethyl-7-methoxyoctan-2-ol; 9-decenol; 10-undecenol; 4-methyl-3-decen-5-ol; aliphatic aldehydes and their acetals such as for example hexanal; heptanal; octanal; nonanal; decanal; undecanal; dodecanal; tridecanal; 2-methyloctanal; 2-methylnonanal; (E)-2-hexenal; (Z)-4-heptenal; 2,6-dimethyl-5-heptenal; 10-undecenal; (E)-4-decenal; 2-dodecenal; 2,6,10-trimethyl-5,9-undecadienal; heptanal-diethylacetal; 1,1-dimethoxy-2,2,5-trimethyl-4-hexene; citronellyl oxyacetaldehyde;

aliphatic ketones and oximes thereof, such as for example 2-heptanone; 2-octanone; 3-octanone; 2-nonanone; 5-methyl-3-heptanone; 5-methyl-3-heptanone oxime; 2,4,4,7-tetramethyl-6-octen-3-one; aliphatic sulfur-containing compounds, such as for example 3-methylthiohexanol; 3-methylthiohexyl acetate; 3-mercaptohexanol; 3-mercaptohexyl acetate; 3-mercaptohexyl butyrate; 3-acetylthiohexyl acetate; 1-menthene-8-thiol; aliphatic nitriles, such as for example 2-nonenenitrile; 2-tridecenenitrile; 2,12-tridecenenitrile; 3,7-dimethyl-2,6-octadienenitrile; 3,7-dimethyl-6-octenenitrile;

aliphatic carboxylic acids and esters thereof, such as for example (E)- and (Z)-3-hexenylformate; ethyl acetoacetate; isoamyl acetate; hexyl acetate; 3,5,5-trimethylhexyl acetate; 3-methyl-2-butenyl acetate; (E)-2-hexenyl acetate; (E)- and (Z)-3-hexenyl acetate; octyl acetate; 3-octyl acetate; 1-octen-3-yl acetate; ethyl butyrate; butyl butyrate; isoamyl butyrate; hexylbutyrate; (E)- and (Z)-3-hexenyl isobutyrate; hexyl crotonate; ethylisovalerate; ethyl-2-methyl pentanoate; ethyl hexanoate; allyl hexanoate; ethyl heptanoate; allyl heptanoate; ethyl octanoate; ethyl-(E,Z)-2,4-decadienoate; methyl-2-octinate; methyl-2-noninate; allyl-2-isoamyl oxyacetate; methyl-3,7-dimethyl-2,6-octadienoate;

acyclic terpene alcohols, such as, for example, citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol 2,6-dimethyl-2,5,7-octatrien-1-ol; as well as formates, acetates, propionates, isobutyrates, butyrates, isovalerates, pentanoates, hexanoates, crotonates, tiglinates and 3-methyl-2-butenoates thereof;

acyclic terpene aldehydes and ketones, such as, for example, geranial; neral; citronellal; 7-hydroxy-3,7-dimethyloctanal; 7-methoxy-3,7-dimethyloctanal; 2,6,10-trimethyl-9-undecenal; α-sinensal; β-sinensal; geranylacetone; as well as the dimethyl- and diethylacetals of geranial, neral and 7-hydroxy-3,7-dimethyloctanal;

cyclic terpene alcohols, such as, for example, menthol; isopulegol; alpha-terpineol; terpinen-4-ol; menthan-8-ol; menthan-1-ol; menthan-7-ol; borneol; isoborneol; linalool oxide; nopol; cedrol; ambrinol; vetiverol; guaiol; and the formates, acetates, propionates, isobutyrates, butyrates, isovalerates, pentanoates, hexanoates, crotonates, tiglinates and 3-methyl-2-butenoates of alpha-terpineol; terpinen-4-ol; methan-8-ol; methan-1-ol; methan-7-ol; borneol; isoborneol; linalool oxide; nopol; cedrol; ambrinol; vetiverol; guaiol;

cyclic terpene aldehydes and ketones, such as, for example, menthone; isomenthone; 8-mercaptomenthan-3-one; carvone; camphor; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexen-1-yl)-2-buten-1-one; 1,3,4,6,7,8a-hexahydro-1,1,5,5-tetramethyl-2H-2,4a-methanonaphthalen-8(5H)-one; nootkatone; dihydronootkatone; acetylated cedarwood oil (cedryl methyl ketone);

cyclic alcohols, such as, for example, 4-tert.-butylcyclohexanol; 3,3,5-trimethylcyclohexanol; 3-isocamphylcyclohexanol; 2,6,9-trimethyl-Z2, Z5, E9-cyclododecatrien-1-ol; 2-isobutyl-4-methyltetrahydro-2H-pyran-4-ol;

cycloaliphatic alcohols, such as, for example, alpha,3,3-trimethylcyclo-hexylmethanol; 2-methyl-4-(2,2,3-trimethyl-3-cyclopent-1-yl)butanol; 2-methyl-4-(2,2,3-trimethyl-3-cyclopent-1-yl)-2-buten-1-ol; 2-ethyl-4-(2,2,3-trimethyl-3-cyclopent-1-yl)-2-buten-1-ol; 3-methyl-5-(2,2,3-trimethyl-3-cyclopent-1-yl)-pentan-2-ol; 3-methyl-5-(2,2,3-trimethyl-3-cyclopent-1-yl)-4-penten-2-ol; 3,3-dimethyl-5-(2,2,3-trimethyl-3-cyclopent-1-yl)-4-penten-2-ol; 1-(2,2,6-trimethylcyclohexyl)pentan-3-ol; 1-(2,2,6-trimethylcyclohexyl)hexan-3-ol;

cyclic and cycloaliphatic ethers, such as, for example, cineole; cedryl methyl ether; cyclododecyl methyl ether;

(ethoxymethoxy)cyclododecane; alpha-cedrene epoxide; 3a,6,6,9a-tetramethyldodecahydronaphtho[2,1-b]furan; 3a-ethyl-6,6,9a-trimethyldodecahydronaphtho[2,1-b]furan; 1,5,9-trimethyl-13-oxabicyclo[10.1.0]-trideca-4,8-diene; rose oxide; 2-(2,4-dimethyl-3-cyclohexen-1-yl)-5-methyl-5-(1-methylpropyl)-1, 3-dioxan;

cyclic ketones, such as, for example, 4-tert.-butylcyclohexanone; 2,2,5-trimethyl-5-pentylcyclopentanone; 2-heptylcyclopentanone; 2-pentylcyclopentanone; 2-hydroxy-3-methyl-2-cyclopenten-1-one; 3-methyl-cis-2-penten-1-y I-2-cyclopenten-1-one; 3-methyl-2-pentyl-2-cyclopenten-1-one; 3-methyl-4-cyclopentadecenone; 3-methyl-5-cyclopentadecenone; 3-methylcyclopentadecanone; 4-(1-ethoxyvinyl)-3,3,5,5-tetramethylcyclohexanone; 4-tert.-pentylcyclohexanone; 5-cyclohexadecen-1-one; 6,7-dihydro-1,1,2,3,3-pentamethyl-4(5H)-indanone; 5-cyclohexadecen-1-one; 8-cyclohexadecen-1-one; 9-cycloheptadecen-1-one; cyclopentadecanone;

cycloaliphatic aldehydes, such as, for example, 2,4-dimethyl-3-cyclohexene carbaldehyde; 2-methyl-4-(2,2,6-trimethyl-cyclohexen-1-yl)-2-butenal; 4-(4-hydroxy-4-methylpentyl)-3-cyclohexene carbaldehyde; 4-(4-methyl-3-penten-1-yl)-3-cyclohexene carbaldehyde;

cycloaliphatic ketones, such as, for example, 1-(3,3-dimethylcyclohexyl)-4-penten-1-one; 1-(5,5-dimethyl-1-cyclohexen-1-yl)-4-penten-1-one; 2,3,8,8-tetramethyl-1,2,3,4,5,6,7,8-octahydro-2-naphtalenyl methyl ketone; methyl-2,6,10-trimethyl-2,5,9-cyclododecatrienyl ketone; tert.-butyl-(2,4-dimethyl-3-cyclohexen-1-yl)ketone;

esters of cyclic alcohols, such as, for example, 2-tert.-butylcyclohexyl acetate; 4-tert.-butylcyclohexyl acetate; 2-tert.-pentylcyclohexyl acetate; 4-tert.-pentylcyclohexyl acetate; decahydro-2-naphthyl acetate; 3-pentyltetrahydro-2H-pyran-4-yl acetate; decahydro-2,5,5,8a-tetramethyl-2-naphthyl acetate; 4,7-methano-3a,4,5,6,7,7a-hexahydro-5 or 6-indenyl acetate; 4,7-methano-3a,4,5,6,7,7a-hexahydro-5 or 6-indenyl propionate; 4,7-methano-3a,4,5,6,7,7a-hexahydro-5 or 6-indenyl-isobutyrate; 4,7-methanooctahydro-5 or 6-indenyl acetate;

esters of cycloaliphatic carboxylic acids, such as, for example, allyl 3-cyclohexyl-propionate; allyl cyclohexyl oxyacetate; methyl dihydrojasmonate; methyl jasmonate; methyl 2-hexyl-3-oxocyclopentanecarboxylate; ethyl 2-ethyl-6,6-dimethyl-2-cyclohexenecarboxylate; ethyl 2,3,6,6-tetramethyl-2-cyclohexenecarboxylate; ethyl 2-methyl-1,3-dioxolane-2-acetate;

araliphatic alcohols, such as, for example, benzyl alcohol; 1-phenylethyl alcohol; 2-phenylethyl alcohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethyl alcohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzyl alcohol; 1-(4-isopropylphenyl)ethanol;

esters of araliphatic alcohols and aliphatic carboxylic acids, such as, for example, benzyl acetate; benzyl propionate; benzyl isobutyrate; benzyl isovalerate; 2-phenylethyl acetate; 2-phenylethyl propionate; 2-phenylethyl isobutyrate; 2-phenylethyl isovalerate; 1-phenylethyl acetate; alpha-trichloromethylbenzyl acetate; alpha,alpha-dimethylphenylethyl acetate; alpha,alpha-dimethylphenylethyl butyrate; cinnamyl acetate; 2-phenoxyethyl isobutyrate; 4-methoxybenzyl acetate; araliphatic ethers, such as for example 2-phenylethyl methyl ether; 2-phenylethyl isoamyl ether; 2-phenylethyl-1-ethoxyethyl ether; phenylacetaldehyde dimethyl acetal; phenylacetaldehyde diethyl acetal; hydratropaaldehyde dimethyl acetal; phenylacetaldehyde glycerol acetal; 2,4,6-trimethyl-4-phenyl-1,3-dioxane; 4,4a,5,9b-tetrahydroindeno[1,2-d]-m-dioxin; 4,4a,5,9b-tetrahydro-2,4-dimethylindeno[1,2-d]-m-dioxin;

aromatic and araliphatic aldehydes, such as, for example, benzaldehyde; phenylacetaldehyde; 3-phenylpropanal; hydratropaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert.-butylphenyl)propanal; 3-(4-tert.-butylphenyl)propanal; cinnamaldehyde; alpha-butylcinnamaldehyde; alpha-amylcinnamaldehyde; alpha-hexylcinnamaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylene-dioxybenzaldehyde; 3,4-dimethoxybenzaldehyde; 2-methyl-3-(4-methoxyphenyl)propanal; 2-methyl-3-(4-methylendioxyphenyl)propanal;

aromatic and araliphatic ketones, such as, for example, acetophenone; 4-methylacetophenone; 4-methoxyacetophenone; 4-tert.-butyl-2,6-dimethylacetophenone; 4-phenyl-2-butanone; 4-(4-hydroxyphenyl)-2-butanone; 1-(2-naphthalenyl)ethanone; benzophenone; 1,1,2,3,3,6-hexamethyl-5-indanyl methyl ketone; 6-tert.-butyl-1,1-dimethyl-4-indanyl methyl ketone; 1-[2,3-dihydro-1,1,2,6-tetramethyl-3-(1-methyl-ethyl)-1H-5-indenyl]ethanone; 5′,6′,7′,8′-tetrahydro-3′,5′,5′,6′,8′,8′-hexamethyl-2-acetonaphthone;

aromatic and araliphatic carboxylic acids and esters thereof, such as, for example, benzoic acid; phenylacetic acid; methyl benzoate; ethyl -benzoate; hexyl benzoate; benzyl benzoate; methyl phenylacetate; ethyl phenylacetate; geranyl phenylacetate; phenylethyl phenylacetate; methyl cinnamate; ethyl cinnamate; benzyl cinnamate; phenylethyl cinnamate; cinnamyl cinnamate; allyl phenoxyacetate; methyl salicylate; isoamyl salicylate; hexyl salicylate; cyclohexyl salicylate; cis-3-hexenyl salicylate; benzyl salicylate; phenylethyl salicylate; methyl 2,4-dihydroxy-3,6-dimethylbenzoate; ethyl 3-phenylglycidate; ethyl 3-methyl-3-phenylglycidate;

nitrogen-containing aromatic compounds, such as, for example, 2,4,6-trinitro-1,3-dimethyl-5-tert.-butylbenzene; 3,5-dinitro-2,6-dimethyl-4-tert.-butylacetophenone; cinnamonitrile; 5-phenyl-3-methyl-2-pentenonitrile; 5-phenyl-3-methylpentanonitrile; methyl anthranilate; methy-N-methylanthranilate; Schiff's bases of methyl anthranilate with 7-hydroxy-3,7-dimethyloctanal, 2-methyl-3-(4-tert.-butylphenyl)propanal or 2,4-dimethyl-3-cyclohexene carbaldehyde; 6-isopropylquinoline; 6-isobutylquinoline; 6-sec.-butylquinoline; indole; skatole; 2-methoxy-3-isopropylpyrazine; 2-isobutyl-3-methoxypyrazine;

phenols, phenyl ethers and phenyl esters, such as, for example, estragole; anethole; eugenol; eugenyl methyl ether; isoeugenol; isoeugenol methyl ether; thymol; carvacrol; diphenyl ether; beta-naphthyl methyl ether; beta-naphthyl ethyl ether; beta-naphthyl isobutyl ether; 1,4-dimethoxybenzene; eugenyl acetate; 2-methoxy-4-methylphenol; 2-ethoxy-5-(1-propenyl)phenol; p-cresyl phenylacetate;

heterocyclic compounds, such as, for example, 2,5-dimethyl-4-hydroxy-2H-furan-3-one; 2-ethyl-4-hydroxy-5-methyl-2H-furan-3-one; 3-hydroxy-2-methyl-4H-pyran-4-one; 2-ethyl-3-hydroxy-4H-pyran-4-one;

lactones, such as, for example, 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 1,15-pentadecanolide; cis- and trans-11-pentadecen-1,15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene-1,12-dodecanedioate; ethylene-1,13-tridecanedioate; coumarin; 2,3-dihydrocoumarin; octahydrocoumarin.

The fragrance system may also contain materials having no odor or very faint odor, which are known as diluents or extenders. Non-limiting examples of these materials are dipropylene glycol, diethyl phthalate, triethyl citrate, isopropyl myristate, and benzyl benzoate. These materials are used for, diluting and stabilizing some other perfume ingredients. These diluents are considered to be additional ingredients and not considered as a fragrance ingredient.

Also the fragrance system includes other non-odorous active ingredients. Some non-limiting examples are: anti-microbial ingredients, UV filters, anti-static ingredients, optical brighteners, cooling agents, and warming agents.

In order to produce a substantive fragrance on the garment or fabric, a study was conducted with a model fragrance (A) in the CO₂ washing process. The deposition of the fragrance ingredients in this model fragrance was analyzed. Molecular modeling was applied to calculate different molecular descriptors. Linear regression was applied to investigate the correlation between molecular features of the fragrance ingredients and their ability to deposit on the garment.

The following procedure was used to calculate advanced molecular descriptors for fragrance chemicals with the COSMO-RS methodology. COSMO-RS is a computational technique well described in the main part of this application.

The procedure started with the generation of three-dimensional conformers of the fragrance chemicals and was assisted by programs such as Hiphop (Molecular Simulation Inc., USA) and HyperChem (Hypercube, Fla., USA).

Afterwards, structures were force field optimized with programs such as Discover (Insight, Molecular Simulation Inc., USA), Merck Molecular Force Field (MMFF, Merck) or Open Force Field (OFF, MSI, USA).

Subsequently, a cluster analysis with NMRClust (Oxford Molecular Ltd., UK) was applied onto the derived structures to gain a large structural complexity. Conformers with a low total energy were preferred in the selection.

The following optimization of the structures was made with semi-empirical calculation programs such as PM3 or AM1 (AMPAC, SemiChem or MOPAC, Fujitsu Ltd.).

An additional cluster analysis was made with NMRClust to select conformers for the following calculations (Oxford Molecular Ltd., UK).

The following structure optimization and energy optimization was made with ab initio methods such as e.g. Hartree-Fock or Møller-Plesset or density function methods (DFT) as like RI-DFT (Turbomol, Chem. Phys. Letters 162 (1989) 165) or GAUSSIAN98 (Gaussian Inc.) or DMol3 (Molecular Simulations Inc.) which included the conductor like screening model option (COSMO).

The DFT/COSMO calculation yielded the total energy of the electrostatic ideal surrounded molecule and the resulting charge density σ on the molecular surface.

In the following step, COSMO-RS (COSMOlogic, Germany) is used to investigate the interaction of fragrance chemicals in liquids with solid materials such as fabric using contact interaction of ideal surrounded molecules (Fluid Phase Equilibria 172 (2000) 43).

The COSMO-RS calculation reduces the interaction of all relevant surface charge densities a on the molecular surface of a fragrance chemical X to the frequency distribution p^{X}(σ). p^{X}(σ) the so-called σ-profile represents the distribution of those parts of the molecular surface with a specific σ.

Textiles can be seen as a complex phase S for which the affinity of a fragrance molecule X can be expressed by a σ-potential μ_{S}(σ). Or the affinity of fragrance molecules X to textiles S can be seen as the affinity of solvent molecules to complex phases. This affinity can be expressed by a σ-potential μ_{S}(σ).

In order to develop molecular descriptors, the following Taylor row for μS(σ) was developed for the subsequent calculation.

$$\begin{matrix}{μ}_{S} ( σ ) ≅ {\sum }_{i = - 2}^{m} {c}_{S}^{i} {f}_{i} ( σ ) \\ \text{with} & ( 1 ) \\ {f}_{i} ( σ ) = {σ}^{i} \text{for} i \geq 0 \\ \text{and} & ( 2 ) \\ {f}_{- 2 / - 1} ( σ ) = {f}_{acc / don} ( σ ) ≅ \{ \begin{matrix}0 & \text{if} & \pm σ < {σ}_{hb} \\ ∓ σ + {σ}_{hb} & \text{if} & \pm σ > {σ}_{hb}\end{matrix} & ( 3 )\end{matrix}$$

wherein

μ_{S}(σ): σ-potential of the phase;

i: Index for the series member;

m: highest order of series member;

fᵢ(σ): Basic function;

f_{acc}: Hydrogen bond acceptor;

c_{S}ⁱ: coefficient of the Taylor row;

f_{don}: Hydrogen bond donor;

σ_{hb}: Threshold for hydrogen bridge bonds.

Any given σ-potential for fragrance chemicals X can be fitted through regression analysis as a result of an equation which uses the hydrogen bridge functions f_{acc} (hydrogen bond acceptor), f_{don} (hydrogen bond donor) and the five polynomes Mᵢ^{X} of the order m=0 to m=4 as descriptors.

Therefore, the chemical potential of a fragrance chemical X on textiles S can be expressed as:

$${μ}_{S}^{X} = \int {p}^{X} ( σ ) {μ}_{S} ( σ ) ⅆ σ ≅ \int {p}^{X} ( σ ) {\sum }_{i = - 2}^{m} {c}_{S}^{i} {f}_{i} ( σ ) ⅆ σ ≅ {\sum }_{i = - 2}^{m} {c}_{S}^{i} {M}_{i}^{X} \qquad ( 4 )$$

wherein the σ-moments Mᵢ^{X} of the fragrance molecule X are defined as

Mᵢ^{X}=∫p^{X}(σ)fᵢ(σ)dσ

These seven σ-moments (f_{acc}, f_{don}, M₀^{X}, M₁^{X}, M₂^{X}, M₃^{X}, M₄^{X}) and μ_{S}^{X} are a very general set of molecular descriptors which can be used according to equation (4) to calculate e.g. fabric affinity values through multi-linear regression.

All kinds of textiles S are then characterized by affinity properties in a linear equation by the coefficients cᵢ^{S} related to the moments Mᵢ^{X}.

Additional descriptors which can be calculated with the COSMO-RS method such as E COSMO (energy of the molecule in the liquid/solid phase calculated with COSMO-RS method), E_{gas} COSMO (Energy of the molecule in the gaseous phase calculated with COSMO-RS method), E _{diel} COSMO (dielectric energy calculated with COSMO-RS method), E _{vdw} COSMO (van der Waals energy of the molecule in a continuum calculated with COSMO-RS method), ΔG COSMO (free energy of the molecule calculated with COSMO-RS method) are used in combination with the seven σ-moments in multi-linear regression analysis.

Using this methodology, the resulting equation determines the fabric affinity value (y) of each fragrance ingredient.

y=a₀+Σaₙxₙ.

wherein y is defined as the predicted relative fabric affinity value or the substantivity of an aroma chemical on a scale of 1-7 with 7 being the most substantive;

wherein xₙ are defined as molecular descriptors derived out of COSMO RS calculations;

wherein a_{0 and} aₙ are defined as coefficients derived from linear regression analysis; and

wherein n is defined as a number from 1 to 5

Moderate odor substantivity was perceived when using fragrance ingredients having a relative fabric affinity value (y) of at least 4.

High odor substantivity was perceived when using fragrance ingredients having a relative fabric affinity value (y) of at least 6.

The present invention uses at least 60%, preferably at least 75%, and most preferred at least 85% of fragrance ingredients in the fragrance system with a relative fabric affinity value of at least 4 to produce a substantive odor on the garment or fabric.

Furthermore, the prevent invention uses at least 50%, preferably at least 60%, and most preferred at least 70% of fragrance ingredients in the fragrance system ingredients with a relative fabric affinity value of at least 6 to produce a substantive odor on the garment or fabric.

The invention is further illustrated but is not intended to be limited by the following example in which all parts and percentages are by weight unless otherwise specified.

### EXAMPLES

The device used for this experiment was an Hewlett Packard 7680T SFE Supercritical Fluid Extractor. 1 g of cotton fabric was put into a 7 ml Thimble. 0.01 grams of the model fragrance A was applied to the uppermost part of the fabric representing the earliest stage of the CO₂ cleaning process.

TABLE 1
Fragrance A

| Parts | Ingredient |
|---|---|
| 2 | Prenyl Acetate |
| 2 | Pinene, Alpha |
| 2 | Pinene, Beta |
| 2 | Limonene D |
| 5 | Dihydro Myrcenol |
| 5 | Phenyl Ethyl Alcohol |
| 5 | Benzyl Acetate |
| 10 | Terpineol, Pure |
| 10 | Phenyl Ethyl Acetate |
| 10 | Geraniol,Supra |
| 10 | Hydroxy Citronellal P |
| 10 | Iso Bornyl Acetate |
| 10 | Dimethyl Benzyl Carbinyl Acetate |
| 10 | Oryclon/Vertenex |
| 10 | Eugenol |
| 10 | Coumarin |
| 10 | Ionone, Alpha |
| 10 | Methyl Ionone Gamma Coeur |
| 10 | Lilial |
| 10 | Iso Amyl Salicylate |
| 10 | Diethyl Phthalate |
| 10 | Cedrol |
| 10 | Amyl Cinnamic Aldehyde |
| 10 | Hexyl Cinnamic Aldehyde |
| 10 | Cedryl Acetate |
| 10 | Benzyl Salicylate |
| 10 | Musk Ketone |
| 10 | Ethylene Brassylate |
| 243 | Total |

The CO₂ properties used were: density=0.25 g/ml, pressure=77 bar (Pc=73.8 bar), temperature=43° C. These were supercritical as the Critical Temperature for CO₂ is 31.1° C.

CO₂ was introduced into the thimble and allowed to soak for 2 min. The thimble was flushed with CO₂ for 5 min at a flow rate of 2 ml/min. The CO₂/fragrance mixture was carried into the trap where the CO₂ was evaporated leaving the fragrance on the analytical trap packing being maintained at −30 deg C. The trap was rinsed with Acetone. The fragrance/acetone mixture was analyzed using gas chromatography with flame ionization detection (GC FID).

The results on the GC FID were used to calculate the % of each fragrance ingredient that was retained on the fabric. (90% means that 90% of the fragrance was substantive on the fabric). The following (Table 2) shows the results.

TABLE 2
Results of Wash Test.

| | | Original on | Washed | % Left on |
|---|---|---|---|---|
| | Parts | Fabric | out | Fabric |
| Prenyl acetate | 2 | 85 | 3 | 97% |
| Pinene, Alpha | 2 | 118 | 1 | 99% |
| Pinene, Beta | 2 | 124 | 1 | 100% |
| Limonene D | 2 | 139 | 3 | 98% |
| Dihydro Myrcenol | 5 | 327 | 86 | 74% |
| Phenyl Ethyl Alcohol | 5 | 354 | 64 | 83% |
| Benzyl Acetate | 5 | 287 | 58 | 80% |
| Terpineol, Pure | 10 | 571 | 176 | 69% |
| Gitronellol 950 | 10 | 665 | 158 | 76% |
| Phenyl Ethyl Acetate | 10 | 652 | 197 | 70% |
| Geraniol, Supra | 10 | 1364 | 315 | 77% |
| Hydroxy Citronellal P | 10 | 607 | 93 | 85% |
| Iso Bornyl Acetate | 10 | 625 | 162 | 74% |
| Dimethyl Benzyl Carbinyl | 10 | 689 | 214 | 69% |
| Acetate | | | | |
| Oryclon/Vertenex | 10 | 684 | 214 | 69% |
| Eugenol | 10 | 602 | 124 | 79% |
| Coumarin | 10 | 583 | 32 | 94% |
| Ionone, Alpha | 10 | 591 | 160 | 73% |
| Methyl Ionone Gamma | 10 | 907 | 237 | 74% |
| Coeur | | | | |
| Lilial | 10 | 801 | 176 | 78% |
| Iso Amyl Salicylate | 10 | 643 | 155 | 76% |
| Diethyl Phthalate | 10 | 604 | 116 | 81% |
| Cedrol | 10 | 903 | 146 | 84% |
| Amyl Cinnamic Aldehyde | 10 | 846 | 144 | 85% |
| Hexyl Cinnamic Aldehyde | 10 | 822 | 113 | 86% |
| Cedryl Acetate | 10 | 896 | 149 | 83% |
| Benzyl Salicylate | 10 | 633 | 58 | 91% |
| Musk Ketone | 10 | 568 | 54 | 91% |
| Ethylene Brassylate | 10 | 669 | 48 | 93% |

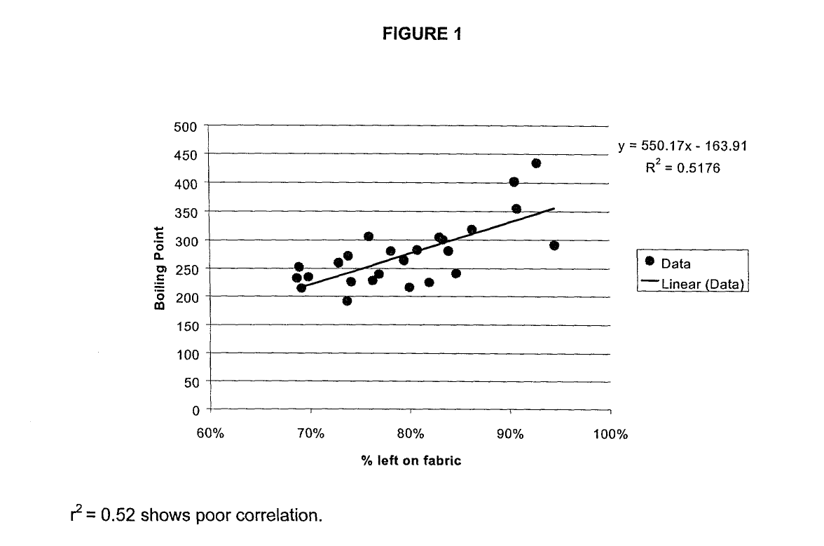

Using traditional descriptors such as Clog P, boiling point and vapor pressure only low correlation coefficients were achieved for the experimental values. FIG. 1 shows the correlation between boiling point and % left on the fabric. r²=0.52 shows a poor correlation.

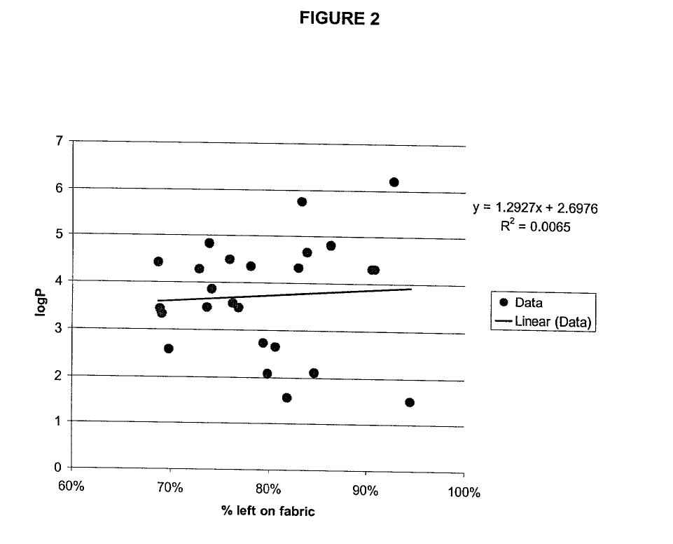

FIG. 2 shows there is no correlation between logP and % left on the fabric. r²=0.0065 shows a very poor correlation.

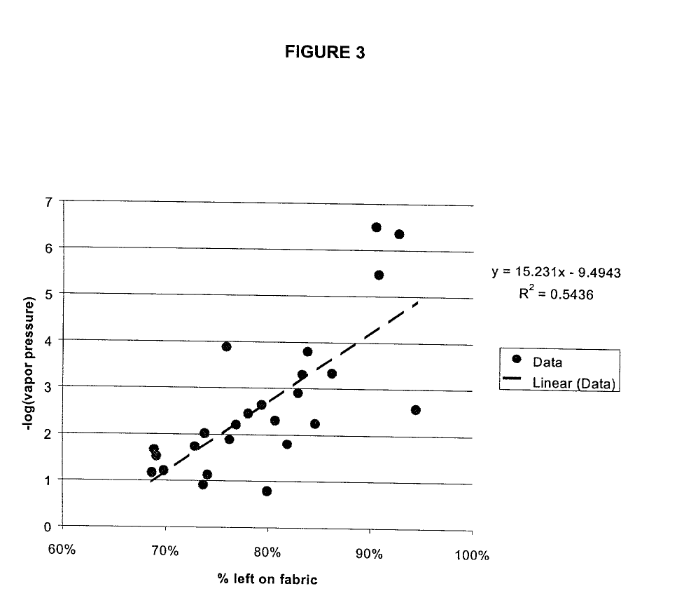

FIG. 3 shows the correlation between −log (vapor pressure) and % left on the fabric. r²=0.54 a shows poor correlation.

The above correlations made with the single descriptors as well as correlations, which contain all descriptors, are not suitable for the prediction of fabric affinity values (y) and therefore, no reliable information can be provided to assist with fragrance creation.

By using COMSO RS descriptors, a much better fit can be achieved allowing the development of a superior predictive model. Using the model fragrance, various molecular descriptors were calculated. The following COSMO RS descriptors were calculated:

σ-moments M₀, M₁, M₂, M₃ and M₄,

Hydrogen bond moments for hydrogen donors (f_{don}) and acceptors (f_{acc})

free energy ΔG_{Cosmo}.

As described in the detailed description of the present invention, these descriptor values are calculated from quantum chemical COSMO calculations for three dimensional structures in the file-formats name.cosmo (Dmol/Turbomole format) or name.cos (MOPAC format) using the COSMOtherm software distributed by COSMOlogic GmbH & Co. KG, Germany.

In this case, structures of compounds were energy minimized and conformers were generated for gas phases and dielectric fields. These structures were again energy minimized (CVFF force field), followed by a semi-empirical calculation with MOPAC and the quantum chemical energy calculation with ridft-process of turbomole.

The COSMO-descriptors and the activity values are put into a table (Table 3) where the compounds are in rows and descriptors and activity values for each compound are in columns. In this analysis, the activity values are defined as the “fraction of each material left on dry fabric after washing as shown in Table 2”.

TABLE 3
Regression Table

| | | | | | | | H_Bond_3_{—} | H_Bond_3_{—} | |
|---|---|---|---|---|---|---|---|---|---|
| Material | activity | σ-M₀ | σ-M₁ | σ-M₂ | σ-M₃ | σ-M₄ | Mom_Acc | Mom_Don | deltaG_Cosmo |
| Ethylene brassylate | 0.928 | 304.3715 | −0.0007 | 87.8146 | 53.3295 | 94.7374 | 0.6823 | 0 | −24.9282 |
| Musk Ketone | 0.905 | 288.1945 | 0.0113 | 84.9118 | 22.3561 | 57.4895 | 0.1046 | 0 | −22.6713 |
| DEP | 0.807 | 250.8838 | 0.0047 | 88.2357 | 40.9015 | 85.8762 | 0.365 | 0 | −21.2179 |
| Hexyl Cinn Aid | 0.863 | 286.7486 | −0.0005 | 62.0299 | 23.913 | 51.3968 | 0.3284 | 0 | −19.5153 |
| Lilial | 0.781 | 261.2472 | 0.0016 | 63.7273 | 24.457 | 48.0025 | 0.2528 | 0 | −19.1351 |
| Benzyl Sal | 0.908 | 259.6201 | 0.0047 | 71.4187 | 1.7256 | 47.1376 | 0.0048 | 0.1873 | −18.9653 |
| Coumarin | 0.945 | 172.4579 | 0.0042 | 72.9706 | 28.5131 | 82.5776 | 0.6921 | 0 | −18.9259 |
| Amyl Cinn Ald | 0.83 | 270.305 | −0.0003 | 60.582 | 22.1066 | 50.8991 | 0.3193 | 0 | −18.6148 |
| Hydroxycitronellal P | 0.846 | 236.0583 | −0.0003 | 84.4313 | 42.7048 | 121.5161 | 1.6422 | 0.4685 | −18.562 |
| Cedryl Acetate | 0.834 | 279.1058 | −0.0015 | 50.8281 | 28.4332 | 49.6005 | 0.49 | 0 | −18.2928 |
| Ionone, alpha | 0.729 | 241.8783 | −0.0006 | 61.0739 | 39.4863 | 70.3229 | 0.9123 | 0 | −18.1457 |
| Dimethyl Benzyl | 0.689 | 235.1953 | 0.0008 | 64.3333 | 26.0883 | 54.0729 | 0.4096 | 0 | −16.8222 |
| Carb Acetate | | | | | | | | | |
| Isoamylsalicylate | 0.759 | 255.8573 | 0.0027 | 62.0354 | 12.2572 | 50.2951 | 0.046 | 0.1785 | −16.697 |
| Oryclon extra 1 | 0.687 | 246.5156 | −0.0008 | 56.3724 | 34.1065 | 58.5465 | 0.4941 | 0 | −16.6605 |
| Benzylacetate | 0.799 | 197.8891 | 0.0027 | 72.3796 | 27.692 | 64.7824 | 0.3846 | 0 | −16.4831 |
| Cedrol, crystals | 0.839 | 253.3473 | −0.0026 | 47.9083 | 15.6906 | 67.7804 | 1.0637 | 0.3791 | −16.476 |
| Phen Eth Acetate | 0.698 | 213.1539 | 0.0019 | 69.3145 | 25.8393 | 56.9434 | 0.323 | 0 | −16.4073 |
| Eugenol | 0.794 | 211.0907 | 0.0043 | 71.0613 | −2.7739 | 66.1703 | 0.0404 | 0.8586 | −16.2769 |
| Isobornylacetate | 0.741 | 229.6193 | −0.0032 | 48.6279 | 28.0637 | 49.6246 | 0.4067 | 0 | −15.726 |
| Citronellol 950 | 0.763 | 231.1161 | −0.0021 | 63.5223 | 20.7436 | 94.9695 | 1.3766 | 0.6708 | −14.7972 |
| Geraniol supra | 0.769 | 224.0376 | 0.0004 | 67.4079 | 18.0173 | 96.9246 | 1.2784 | 0.8081 | −14.723 |
| Terpineol Pure | 0.691 | 202.4417 | −0.0015 | 55.1661 | 23.6513 | 79.1806 | 1.3108 | 0.3314 | −14.2052 |
| Dihydromyrcenol | 0.737 | 227.1079 | −0.0012 | 56.4309 | 24.3864 | 77.4421 | 1.3227 | 0.302 | −14.0568 |
| Prenyl Acetate | 0.969 | 185.8894 | 0.0017 | 61.0278 | 32.3413 | 61.077 | 0.4309 | 0 | −13.397 |
| Limonene D | 0.977 | 196.1279 | −0.0027 | 27.5407 | 8.2705 | 11.4017 | 0 | 0 | −11.0721 |
| beta-Pinene | 0.995 | 182.1707 | −0.0021 | 20.6974 | 4.8988 | 7.2647 | 0 | 0 | −10.232 |
| alpha-Pinene | 0.989 | 182.9476 | −0.0033 | 15.5479 | 2.0076 | 3.7672 | 0 | 0 | −9.6842 |

An equation describing the behavior of the volatile chemicals contained in the model fragrance A in the wash was determined by several multiple linear regressions using the above table of descriptors and activities. The following equation was selected because of the best validation data:

Fabric affinity value (y)=0.2771+(−0.0042*“M₂”)+(−0.0094*“M₃”)+(0.0061*“M₄”)+(−0.2738*“f_{don}”)+(−0.0377*“ΔG_{Cosmo}”), Equation 6

with validation values: r²=0.85; F-test=19; xvr²=0.75.

Since the calculated values are to be used in perfume creation, the fabric affinity values were calculated as integers in the range of 1-7 by using the following equation 7. In this equation 7, the activity values were re-scaled between 0.30 and 0.82, producing fabric affinity values between 1-7. These fabric affinity values were rounded to the nearest integer.

Fabric affinity value (y)=8*activity/0.82+9−6.56/0.52 Equation 7

Therefore, to calculate the predicted fabric affinity values for aroma chemicals, the activity of each chemical is calculated with the correlating COSMO-descriptors according to the above-mentioned Equation 6. Subsequently, the activities are scaled between 0.82 and 0.30. Subsequently, the fabric affinity values are calculated according to Equation 7. Values for chemicals calculated to be greater than 7 are set equal to 7 by definition; values for chemicals calculated to be smaller than 1 are set equal to 1 by definition.

Using the above listed experimental data and equations 6 and 7, the following Table 4 shows the fabric affinity values for selected aroma chemicals in this cleaning system.

TABLE 4

| Product Name | Fabric Affinity Value (1-7) |
|---|---|
| METHYL BUTYRATE | 2 |
| ETHYL PROPIONATE | 2 |
| ETHYLBUTYRATE | 3 |
| ALDEHYDE C 6 | 3 |
| VERTOCITRAL | 3 |
| HEXENYLACETATE CIS-3 | 3 |
| ETHYLCAPRONATE | 3 |
| BENZALDEHYDE | 4 |
| METHYLBENZOATE H&R | 4 |
| HERBAFLORAT | 4 |
| PHENYLACETALDEHYD 100% | 4 |
| TERPINOLENE | 4 |
| EUCALYPTOL | 4 |
| BENZYLACETATE | 4 |
| CITRAL PURE H&R | 4 |
| MYRCENE SUPRA | 4 |
| CYCLABUTE | 4 |
| FLORALOZONE | 4 |
| ISOBORNYLACETATE | 4 |
| MUSK C14 | 4 |
| CPD-KETONE | 5 |
| CYCLOPENTADECANOLIDONE | |
| MENTHYLACETATE RF | 5 |
| AGRUMEX HC | 5 |
| ALDEHYDE C10 | 5 |
| HEDION | 5 |
| NEROLIONE H&R | 5 |
| DATILAT | 5 |
| DECENAL TRANS-2 | 5 |
| CYCLAMENALDEHYDE | 5 |
| ETHYLENBRASSYLATE | 5 |
| ISORALDEIN 70 | 5 |
| AMBRETTOLIDE | 5 |
| CITRONITRIL | 5 |
| LILIAL | 5 |
| ALDEHYDE C14 | 5 |
| MALTOL | 5 |
| COUMARONE H&R | 5 |
| VANILLIN | 5 |
| ALDEHYDE C12 MNA | S |
| LINALOOL FF | 5 |
| ETHYLVANILLIN | 5 |
| EUGENOL | 5 |
| AMBROX DL | 5 |
| GLOBALIDE 100% | 5 |
| CEDRAMBER | 5 |
| TERPINEOL ALPHA | 6 |
| LYRAL | 6 |
| GERANIOL 60 | 6 |
| FREESIOL/CORPS 119 | 6 |
| MENTHOL L DIST. | 6 |
| NEONITRIL H&R | 6 |
| CITRONELLOL 950 | 6 |
| SANDOLENE H&R | 6 |
| MANDARIL | 6 |
| SANDEL E / CORPS 760 | 6 |
| PROFARNESOL | 7 |
| METHYLANTHRANILATE | 7 |
| HEXAHYDROIRALDEIN | 7 |
| BENZYLCINNAMATE | 7 |
| BENZYLSALICYLATE | 7 |
| JASMOL | 7 |
| HYDROXYCITRONELLOL | 7 |
| PHYTOL | 7 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for cleaning soiled garments or fabric materials comprising the steps of:
A) placing said soiled garments or fabric materials into a sealable and pressurizable device;
B) introducing into the device a cleaning agent comprising CO₂, which comprises a fragrance system;
C) contacting said soiled garments or fabric materials with said cleaning agent to remove undesired stains or soils and to deposit a substantive long lasting fragrance system on said garment or fabric materials.

2. The process according to claim 1, wherein said CO₂ is liquid CO₂.

3. The process according to claim 1, wherein said CO₂ is supercritical CO₂.

4. The process according to claim 1, wherein said fragrance system comprises fragrance ingredients that are determined to be substantive to garments according to the following mathematical equation:
y=a₀+Σaₙxₙ.
wherein y is defined as the predicted relative fabric value affinity of an aroma chemical on having a range of from about 1-7 with 7 being the most substantive;
wherein X₁₋ₙ are defined as molecular descriptors derived out of COSMO RS calculations; n is defined as number of descriptors used in the said equation,
wherein a₀₋ₙ are defined as coefficients derived from linear regression analysis.

5. The process according to claim 4, wherein a₀=0.2771, a₁=−0.0042, a₂=−0.0094, a₃=0.0061, a₄=−0.2738 and a₅=−0.0377; and x₁=σ-moment M₂, x₂=σ-moment M₃, x₃=σ-moment M₄, x₄=f_{don}, and x₅=ΔG_{Cosmo}; and n=5.

6. The process according to claim 4, wherein at least 60% of said fragrance ingredients have a relative fabric affinity value (y) of at least 4.

7. The process according to claim 6, wherein at least 75% of said fragrance ingredients have a relative fabric affinity value (y) of at least 4.

8. The process according to claim 7, wherein at least 85% of said fragrance ingredients have a relative fabric affinity value (y) of at least 4.

9. The process according to claim 4, wherein at least 50% of said fragrance ingredients have a relative fabric affinity value (y) of at least 6.

10. The process according to claim 9, wherein at least 60% of said fragrance ingredients have a relative fabric affinity value (y) of at least 6.

11. The process according to claim 10, wherein at least 70% of said fragrance ingredients have a relative fabric affinity value (y) of at least 6.

12. The process according to claim 1, wherein said fragrance system comprises additional additives selected from the group consisting of anti-microbial ingredients, UV filters, anti-static ingredients, optical brighteners, cooling agents, and warming agents.

13. A fragrance system for use in a liquid CO₂ cleaning system comprises fragrance ingredients that are determined to be substantive to garments according to the following mathematical equation:
y=a₀+Σaₙxₙ.
wherein y is defined as the predicted relative substantivity of an aroma chemical on having a range of from about 1-7 with 7 being the most substantive;
wherein x₁₋ₙ are defined as molecular descriptors derived out of COSMO RS calculations; wherein n is defined as number of descriptors used in the said equation, wherein a₀₋ₙ are defined as coefficients derived from linear regression analysis.

14. The process according to claim 13, wherein a₀=0.2771, a₁=−0.0042, a₂=−0.0094, a₃=0.0061, a₄=−0.2738 and a₅=−0.0377; and x₁=σ-moment M₂, x₂=σ-moment M₃, x₃=σ-moment M₄, x₄=f_{don}, and x₅=ΔG_{Cosmo}; and n=5.

15. The fragrance system according to claim 13, wherein at least 60% of said fragrance ingredients have a relative fabric affinity value (y) of at least 4.

16. The fragrance system according to claim 15, wherein at least 75% of said fragrance ingredients have a relative fabric affinity value (y) of at least 4.

17. The fragrance system according to claim 16, wherein at least 85% of said fragrance ingredients have a relative fabric affinity value (y) of at least 4.

18. The fragrance system according to claim 13, wherein at least 50% of said fragrance ingredients have a relative fabric affinity value (y) of at least 6.

19. The fragrance system according to claim 18, wherein at least 60% of said fragrance ingredients have a relative fabric affinity value (y) of at least 6.

20. The fragrance system according to claim 19, wherein at least 70% of said fragrance ingredients have a relative fabric affinity value (y) of at least 6.

21. The fragrance system according to claim 13, wherein said fragrance system comprises additional additives selected from the group consisting of anti-microbial ingredients, UV filters, anti-static ingredients, optical brighteners, cooling agents, and warming agents.
